(19) United States
(12) Patent Application Publication
(10) Pub. No.: US 2023/0056671 A1
(43) Pub. Date: Feb. 23, 2023

(54) VEHICLE, TRAILER AND AIRCRAFT COMPRISING AN ENERGY CONVERSION SYSTEM FOR CONVERTING WIND ENERGY INTO ELECTRICAL ENERGY AND AN ENERGY CONVERSION SYSTEM AND USE THEREOF

(71) Applicant: Ingenieurbüro Immig GmbH, Bad Kreuznach (DE)

(72) Inventor: Mario Immig, Bad Kreuznach (DE)

(21) Appl. No.: 17/893,610

(22) Filed: Aug. 23, 2022

(30) Foreign Application Priority Data
Aug. 23, 2021 (EP) 21192622.5

(51) Int. Cl. H02K 7/18; B64D 27/24; B64C 27/46; F03D 9/32; F03D 1/04; B60L 8/00

(52) U.S. Cl. CPC H02K 7/183; B60L 8/006; B64C 27/46; B64D 27/24; F03D 1/04; F03D 9/32; B60L 2200/10

(57) ABSTRACT

A vehicle having an energy conversion system for converting wind energy into electrical energy includes a rotor with a rotor axis of rotation, which is oriented substantially parallel to the longitudinal axis of the vehicle or forms an acute angle with the longitudinal axis, wherein the energy conversion system is closer to the rear end than to the front end of the vehicle. Also described is a trailer comprising an energy conversion system for converting wind energy into electrical energy. In addition, an aircraft is described, including an energy conversion system for converting wind energy into electrical energy. Moreover, the energy conversion system is usable to improve the driving characteristics of vehicles. A headwind deflection system for vehicles also includes an energy conversion system for converting wind energy into electrical energy, comprising a rotor, a flow channel and a wind funnel. In addition, a kit of parts may include a vehicle and the headwind deflection system.

### BACKGROUND

### Technical Field

The present disclosure relates to a vehicle, such as a passenger car or truck, having at least one energy conversion system for converting wind energy into electrical energy, in some cases wind energy generated by headwind of the vehicle. Furthermore, the present disclosure also relates to a trailer having at least one energy conversion system for converting wind energy into electrical energy, in some cases wind energy generated by the headwind of the vehicle. Further, the present disclosure relates to an aircraft having at least one energy conversion system for converting wind energy into electrical energy, in some cases wind energy generated by the headwind of the aircraft. The present disclosure also relates to the use of an energy conversion system as described above for improving the driving characteristics of vehicles. The present disclosure further relates to a headwind deflection system for vehicles. Finally, the present disclosure relates to a kit comprising a vehicle in the form of a car or truck and a headwind deflection system for installation on a vehicle and a kit for a headwind deflection system, a framework and at least one planar barrier device, such as a sail.

### Description of the Related Art

Vehicles such as cars, trucks and trains, but also aircraft, generally still use propulsion based on internal combustion engines. In addition to fossil fuels, renewable sources are also increasingly being used. However, even with the use of electrical energy for locomotion, ultimately fossil fuels are still regularly used. Furthermore, substantially all of the currently used propulsion systems are dependent on stopping the vehicle to receive fuel such as gasoline, gas, kerosene, but also electricity.

US 2020/0189397 A1, incorporated by reference herein, describes an energy recovery system for a wind-driven electric vehicle, comprising (a) a movable front channel provided with air slots having a plurality of slats which are integrated in a functional manner into a front apron of an electric vehicle, (b) at least one windshield vent which is operably positioned to vent air at a base edge of a windshield of the electric vehicle, (c) a first wind chamber operably connected to the front channel and the at least one windshield opening so that air flows into the front channel and out of the at least one windshield opening, (d) an air velocity sensor on the front apron of the electric vehicle, adapted and arranged to control the plurality of slats of the front channel into an open position when the air velocity sensor detects a net headwind against the front apron of the electric vehicle, and to move said plurality of slats into a closed position when the air velocity sensor does not identify any net headwind against the front apron of the electric vehicle, and (e) at least one front double turbine system having (i) a main body, (ii) a first tube and a second tube, wherein the first tube and the second tube are arranged within the main body, and wherein each tube is open at a front end and a rear end, (iii) a first turbine and a second turbine, wherein the first turbine is housed in the first tube, and wherein the second turbine is housed in the second tube, (iv) at least one transmission operably connected to the first turbine and the second turbine, (v) a generator operably connected to the transmission; and (vi) a capacitor operably connected to the generator to charge a battery that drives the electric vehicle. In this case, the at least one double turbine system has to be positioned operatively within the first wind chamber so that the air flowing through the wind chamber causes at least one rotor of the first turbine and at least one rotor of the second turbine to rotate. However, such systems are disadvantageous in many respects. Air of any temperature is guided through the car by means of the air channel running exclusively in the interior of the vehicle. This causes the car to heat up or cool more quickly, but also causes large amounts of condensation water to form in the car under certain circumstances. Furthermore, such a system constitutes a large intervention in the design of the vehicle.

Thus, there is accordingly a need to provide such a system which increases the range and/or the service life of a vehicle, in some cases without fuel or electrical energy having to be received at stationary charging stations.

### BRIEF SUMMARY

According to a first aspect, the present disclosure provides a vehicle, in the form of a car or truck, with a front and a rear end and a longitudinal axis extending between the front end and the rear end, having at least one energy conversion system, in some cases present outside the vehicle body, for converting wind energy into electrical energy, in some cases wind energy generated by headwind of the vehicle, comprising at least one rotor having a rotor axis of rotation, the rotor comprising a plurality of rotor blades extending radially with respect to the rotor axis of rotation, wherein the rotor has an inflow direction which corresponds to the rotor axis of rotation, in some cases is parallel to the rotor axis of rotation, and a flow housing having a rotor mantle which surrounds the rotor, in some cases entirely, wherein the rotor axis of rotation is oriented substantially parallel to the longitudinal axis or forms an acute angle with the longitudinal axis, wherein the intersection of the longitudinal axis and the rotor axis of rotation and the energy conversion system are located closer to the rear end than to the front end of the vehicle. In the case of the acute angle formed from the longitudinal axis and the rotor axis of rotation (or its extension), according to the present disclosure, the longitudinal axis forms the leg lying below the rotor axis of rotation (or its extension). With the vehicle according to the present disclosure, energy generated from the headwind during an entire journey can be utilized, i.e., be made available to the vehicle for conversion into kinetic energy. As a result of the generation of energy during travel, the energy stores can be smaller than in the case of vehicles which can only be charged at a standstill. This leads to considerable weight reductions in the vehicle and thus to a lower energy requirement. Furthermore, the reduction in the energy storage systems results in considerable resources being saved in vehicle construction, in some cases also in the form of metals. Finally, the arrangement of the energy conversion system in the rear part of the vehicle results in no additional pressure loss, which would lead to increased consumption of the vehicle.

### BRIEF DESCRIPTION OF THE DRAWINGS

Further features and advantages of the present disclosure arise from the following description, in which exemplary embodiments of the invention are explained by way of example with reference to schematic drawings, without thereby limiting the present invention, in which:

FIG. 1 shows a side view of a vehicle according to the present disclosure, such as a passenger car, comprising an energy conversion system;

FIG. 2 shows a plan view of a vehicle according to the present disclosure, such as a passenger car, comprising an energy conversion system;

FIG. 3 shows a side view of an alternative embodiment of a vehicle according to the present disclosure, such as a passenger car, comprising two energy conversion systems;

FIG. 4 shows a plan view of an alternative embodiment of the energy conversion system according to the first aspect of the present disclosure;

FIG. 4a shows a plan view of an alternative embodiment of the energy conversion system according to the first aspect of the present disclosure with a changed inflow direction of the guiding unit;

FIG. 4b shows a plan view of an alternative embodiment of the energy conversion system according to the first aspect of the present disclosure with a changed inflow direction of the guiding unit;

FIG. 5 shows a side view of an alternative embodiment of a vehicle according to the present disclosure for attachment to the roof of a vehicle;

FIG. 6 shows a side view of a headwind deflection system according to the present disclosure for attachment to the rear side of a passenger car;

FIG. 6a shows a side view of an alternative embodiment of a headwind deflection system according to the present disclosure for attachment to the rear side of a passenger car;

FIG. 6b shows a side view of a further alternative embodiment of a headwind deflection system according to the present disclosure for attachment to the rear side of a passenger car;

FIG. 6c shows a side view of an alternative embodiment of a headwind deflection system according to the present disclosure for attachment to the rear side of a passenger car;

FIG. 7 shows a side view of a trailer according to the present disclosure;

FIG. 7a shows a side view of an alternative embodiment of a trailer according to the present disclosure;

FIG. 8 shows a side view of a trailer according to the present disclosure in the form of a train car;

FIG. 8a shows a plan view of a trailer according to the present disclosure in the form of a train car;

FIG. 8b shows a side view of an alternative embodiment of a trailer according to the present disclosure in the form of a train car;

FIG. 9 shows a side view of an aircraft according to the present disclosure;

FIG. 9a shows a side view of an alternative embodiment of an aircraft according to the present disclosure.

### DETAILED DESCRIPTION

In a further embodiment of the vehicle according to the present disclosure, the flow housing further comprises at least one wind funnel, in some cases two wind funnels, which are adapted and arranged to guide a headwind, in some cases a headwind airflow, to the rotor. With the aid of the wind funnels, the headwind can be directed onto the rotor in a targeted manner, as a result of which its yield can be increased. In this case, the wind funnels expediently extend from the rotor mantle in a channel-like, in some cases circular, in some other cases elliptical or angular, in some even other cases polygonal, some even other cases quadrangular, manner.

In an expedient embodiment of the vehicle according to the present disclosure, the first wind funnel is arranged upstream of the rotor mantle and tapers in the direction of the rotor mantle, and/or a second wind funnel is arranged downstream of the rotor mantle and widens in the direction away from the rotor mantle, wherein the first wind funnel is adapted and arranged to receive headwind and the second wind funnel is adapted and arranged to direct the output airflow in the direction of the vehicle end which is counter to the direction of travel.

By using tapering or widening funnels, the wind speeds acting on the rotor are significantly increased, in some cases by at least 20%, in some further cases by at least 40%, in some even further cases by at least 60%. By increasing the wind speed, the yield of the energy conversion system can be increased, which regularly involves an increased range of the vehicle according to the present disclosure.

In a further, expedient embodiment of the vehicle according to the present disclosure, the rotor is arranged in the rotor mantle at an axial distance from one or more wind funnels. The axial distance extends between the inner end of a wind collector funnel, in some cases where the wind collector funnel meets the rotor mantle, and the rotor itself. By providing an axial distance, it can be ensured that the wind then impinges on the rotor in the direction of rotation thereof.

In a highly expedient embodiment of the vehicle according to the present disclosure, the second wind funnel is arranged so as to be pivotably movable transverse to the vehicle longitudinal axis, in some cases mechanically, electrically, pneumatically and/or hydraulically pivotably movable, about the end of the rotor mantle, so that the inflow angle of the output airflow to the guiding unit, in some cases spoiler, of a vehicle changes, in some cases changes by up to approximately 45° on both sides of the vehicle longitudinal axis. With the pivoting mobility of the second wind funnel, it is surprisingly possible for the contact pressure of the vehicle to be increased by targeted guiding of the output airflow onto the guiding unit of the vehicle. This can be used, for example, during fast cornering to improve the driving safety of the vehicle.

In a further highly expedient embodiment of the vehicle according to the present disclosure, the energy conversion system is mounted at the rear. Locating the energy conversion system at the rear of a vehicle has the large advantage that, on the one hand, there is no undesirable pressure loss, increasing the energy requirement of the vehicle. On the other hand, in this way no complex intervention in the vehicle structure for installation of the energy conversion system is required either.

In an expedient embodiment of the vehicle according to the present disclosure, the energy conversion system is mounted on the roof, a roof rack, a roof basket or a roof box of the vehicle via a mount comprising at least one strut and/or via the trailer hitch. The mount makes it possible to securely, retroactively install the energy conversion system in a simple and reliable manner even in existing vehicles.

In an alternative embodiment, the vehicle according to the present disclosure may further comprise a second energy conversion system, as described above, in the interior of the vehicle. By using a second energy conversion system, the energy production of the vehicle can be further increased. However, it is generally already sufficient to attach just one energy conversion system to the exterior of the vehicle in order to provide sufficient energy for the locomotion of the vehicle.

According to a second aspect of the present disclosure, a trailer, such as a car trailer or truck trailer or train car at the end of a sequence of train cars, is provided having a front and a rear end and a longitudinal axis extending between the front end and the rear end, comprising at least one energy conversion system for converting wind energy into electrical energy, in some cases wind energy generated by headwind of a vehicle, having at least one rotor with a rotor axis of rotation, comprising a plurality of rotor blades extending radially with respect to the rotor axis of rotation, wherein the rotor axis of rotation is oriented substantially parallel to the longitudinal axis or forms an acute angle with the longitudinal axis, wherein the intersection of the longitudinal axis and the rotor axis of rotation is located closer to the rear end than to the front end of the trailer. By using an energy conversion system as described above with a trailer, advantage can also be taken of the energy conversion system by trucks or trains, for example, without extensive modification of the vehicle itself. In this way, in some cases as described above, the pulling machine can be supplied with energy and/or an on-board battery can be charged.

In a further embodiment of the trailer according to the present disclosure, the energy conversion system further comprises a flow housing having a rotor mantle which surrounds the rotor, in some cases entirely.

In an expedient embodiment of the trailer according to the present disclosure, the flow housing further comprises at least one wind funnel, in some cases two wind funnels, which is/are adapted and arranged to guide a headwind, in some cases a headwind airflow, to the rotor, wherein in some cases a first wind funnel is arranged upstream of the rotor mantle and tapers in the direction of the rotor mantle, and/or wherein a second wind funnel is arranged downstream of the rotor mantle and widens in the direction away from the rotor mantle, wherein the first wind funnel is adapted and arranged to receive the headwind and the second wind funnel is adapted and arranged to direct the output airflow in the direction of the vehicle end which is counter to the direction of travel. By using tapering or widening funnels, the wind speeds which act on the rotor can be increased, in some cases by at least 20%, in some other cases by at least 40%, in some even other cases by at least 60%. By increasing the wind speed, the yield of the energy conversion system can be increased. Such embodiments of the trailer according to the present disclosure are highly expedient in which the wind funnel extends from the rotor mantle in a channel-like, in some cases circular, in some other cases elliptical or angular, in some even other cases polygonal, in some cases quadrangular, manner.

In a further embodiment of the trailer according to the present disclosure, the rotor is arranged in the rotor mantle at an axial distance from the plurality of wind funnels. The axial distance extends between the inner end of a wind collector funnel, in some cases where the wind collector funnel meets the rotor mantle, and the rotor itself. By providing an axial distance, it can be ensured that the wind then impinges on the rotor in the direction of rotation thereof.

In an expedient embodiment of the trailer according to the present disclosure, the trailer furthermore has a trailer shell, comprising at least one opening, which is adapted and arranged to receive the headwind, and wherein the trailer shell furthermore has at least one outlet which is adapted and arranged to discharge the output airflow to the surroundings of the trailer.

In a further embodiment of the trailer according to the present disclosure, the at least one rotor is arranged so as to be pivotably movable transverse to the rotor axis of rotation, in some cases about an in some cases vertical pivot axis and/or an in some cases horizontal tilt axis, in some cases between at least two rotor orientations, in some cases relative to the trailer shell. The pivoting mobility of the rotor results in the rotor being able to be optimally oriented at any time with respect to the impinging wind so that its yield is increased.

Trailers in the sense of the trailer according to the present disclosure are in some cases car trailers or truck trailers or a train car at the end of a sequence of train cars.

According to a third aspect of the present disclosure, an aircraft is provided, comprising an energy conversion system for converting wind energy into electrical energy, in some cases wind energy generated by headwind of the aircraft, comprising at least one rotor with a rotor axis of rotation, comprising a plurality of rotor blades extending radially to the rotor axis of rotation, wherein the rotor has an inflow direction which corresponds to the rotor axis of rotation, in some cases is parallel to the rotor axis of rotation, and a flow housing having a rotor mantle which surrounds the rotor, in some cases entirely, wherein the rotor axis of rotation is oriented substantially parallel to the longitudinal axis of the aircraft. In some cases, in aircraft moving at a considerable speed, the energy conversion system may help to provide considerable amounts of electrical energy for propulsion of the aircraft. Additionally or alternatively, the energy conversion system can be switched on during landing approach or braking, wherein electrical energy can be generated which can be stored in on-board batteries.

In an expedient embodiment of the aircraft according to the present disclosure, the flow housing further comprises at least one wind funnel which is adapted and arranged to guide a headwind, in some cases a headwind airflow, to the rotor, wherein in some cases a first wind funnel is arranged upstream of the rotor mantle and tapers in the direction of the rotor mantle, wherein the first wind funnel is adapted and arranged to receive the headwind, and/or a second wind funnel is adapted and arranged to direct the output airflow in the direction of the aircraft which is counter to the direction of travel. By using tapering or widening funnels, the wind speeds which act on the rotor can be increased, in some cases by at least 20%, in some other cases by at least 40%, in some even other cases by at least 60%. By increasing the wind speed, the yield of the energy conversion system can be increased. Such embodiments of the aircraft are expedient in which the wind funnel extends from the rotor mantle in a channel-like, in some cases circular, in some other cases elliptical or angular, in some even other cases polygonal, such as quadrangular, manner.

In an expedient embodiment of the aircraft according to the present disclosure, the rotor is arranged in the rotor mantle at an axial distance from the first and/or second wind funnel. The axial distance extends between the inner end of a wind collector funnel, in some cases where the wind collector funnel meets the rotor mantle, and the rotor itself. By providing an axial distance, it can be ensured that the wind then impinges on the rotor in the direction of rotation thereof.

The present disclosure further discloses the use of an energy conversion system, as described above on the basis of general and expedient embodiments, for improving the driving characteristics of vehicles, such as passenger cars, in some cases by increasing the contact pressure, in some cases on curved sections of road. No energy conversion systems have been hitherto known from the prior art which are used not only for generating electrical current but also for increasing the driving safety of a vehicle by influencing vehicle aerodynamics. With the energy conversion system according to the present disclosure, this is achieved in some cases by the guidance of the output airflow, adapted to a driving situation, to a guiding unit mounted on the rear of the vehicle.

According to a fourth aspect of the present disclosure a headwind deflection system for vehicles, such as passenger cars or trucks, is provided, comprising an energy conversion system for converting wind energy into electrical energy, in some cases wind energy generated by headwind of the vehicle, comprising at least one rotor with a rotor axis of rotation, comprising a plurality of rotor blades extending radially to the rotor axis of rotation, wherein the rotor has an inflow direction which corresponds to the rotor axis of rotation, in some cases is parallel to the rotor axis of rotation, and a flow channel with a rotor mantle, which surrounds the rotor, in some cases entirely, wherein the rotor axis of rotation and the rotor mantle can be arranged substantially vertically on the rear side of a vehicle, wherein the flow channel comprises at least one first wind funnel which can be arranged above the roof of a vehicle, upstream with respect to the rotor, and is adapted and arranged to guide headwind via a first manifold and the rotor mantle. By using a manifold, the headwind deflection system can be arranged on the vehicle in such a way that the angle between the vehicle longitudinal axis and the rotor axis of rotation is substantially 90°, in some cases even greater than 90°. This makes it possible to attach the headwind deflection system to the trunk or to the rear side of a vehicle so that only the opening of the at least one wind funnel, which is adapted and arranged to receive the headwind, is in the headwind. The remaining part of the energy conversion system is then present, for example, on the rear side of the vehicle. This has the advantage that the headwind deflection system according to the present disclosure can easily be integrated into existing vehicles and can be used there as an additional energy source, for example, in order to charge the on-board battery. This further has the advantage that the ranges of conventional electric vehicles can be increased.

In an expedient embodiment of the headwind deflection system according to the present disclosure for vehicles, the headwind deflection system further comprises a second wind funnel, which is present or can be arranged downstream with respect to the rotor, and is adapted and arranged to guide the headwind away from the rotor, and/or a second manifold in the transition from the rotor mantle to the second wind funnel, and is adapted and arranged to convey the headwind originating from the rotor away from the vehicle.

In a further particularly expedient embodiment of the headwind deflection system according to the present disclosure for vehicles, the headwind deflection system further comprises a second manifold in the transition from the rotor mantle to the second wind funnel, and is adapted and arranged to convey the headwind originating from the rotor away from the vehicle.

Such embodiments of the headwind deflection system according to the present disclosure for vehicles are expedient in which the wind funnels extend from the rotor mantle in a channel-like, in some cases circular, in some other cases elliptical or angular, in some even other cases polygonal, such as quadrangular, manner.

In expedient embodiments of the headwind deflection system according to the present disclosure, at least one rotor is arranged in the rotor mantle at an axial distance from the first and/or second wind funnel. The axial distance extends between the inner end of a wind collector funnel, in some cases where the wind collector funnel meets the rotor mantle, and the rotor itself. By providing an axial distance, it can be ensured that the wind then impinges on the rotor in the direction of rotation thereof.

In a highly expedient embodiment of the headwind deflection system according to the present disclosure, the headwind deflection system can be mounted on or at the rear side and/or the roof of a vehicle via at least one strut and/or via a coupling unit, such as a trailer hitch, and/or via a belt system or lashing. It is thus possible to retrofit the headwind deflection system very easily with existing vehicles.

In a further highly expedient embodiment of the headwind deflection system according to the present disclosure, the energy conversion system can be attached to the vehicle in a pivotable and/or foldable manner via the coupling unit, such as the trailer hitch. Such an attachment makes it possible for the vehicle to continue to be opened, for example to load the trunk, even after installation of the headwind deflection system on the rear side of a vehicle, in some cases in the region of the trunk opening.

The present disclosure further relates to a kit of parts comprising a vehicle, such as a passenger car or truck, and to a headwind deflection system according to the present disclosure, in some cases as described above.

The present disclosure also relates in some cases to a kit of parts for a headwind deflection system according to the present disclosure, as described above, comprising a framework, in some cases in the form of a framework structure, for the flow housing of the energy conversion system, comprising the rotor mantle and optionally the first and/or second wind funnel and/or the first and/or second manifold, and at least one planar barrier device, such as a sail, adapted and arranged to span the framework at least in sections, so that headwind can be directed to the at least one rotor. By means of the kit according to the present disclosure, it is even possible to make a headwind deflection system according to the present disclosure for a vehicle ready for use.

The present disclosure is associated with the surprising finding that, with the rear attachment of a suitable energy conversion system to a vehicle, energy can be obtained in a very efficient manner from the headwind of the vehicle with the aid of a rotor according to the resistance principle, in some cases so much energy that stationary charging of the vehicle with electrical energy can be significantly delayed. It is also of a large advantage that the driving safety can be increased with vehicles according to the present disclosure which are equipped at the rear with the energy conversion system. Very surprisingly, it has also been found that a considerable amount of electrical energy can be reliably generated from headwind when trailers according to the present disclosure are used. Finally, it has proven to be highly advantageous that existing vehicles can be retrofitted with the described energy conversion system according to the present disclosure.

FIG. 1 shows a passenger car having a front and a rear end and a longitudinal axis L extending between the front end and the rear end, having an energy conversion system 1, which is present outside the body of the vehicle, for converting wind energy into electrical energy, in some cases wind energy generated by headwind of the vehicle, comprising a rotor 3 with a rotor axis of rotation D, comprising a plurality of rotor blades 31 extending radially with respect to the rotor axis of rotation D, wherein the rotor 3 has an inflow direction which corresponds to the rotor axis of rotation D, in some cases parallel to the rotor axis of rotation D, and a flow housing 4 with a rotor mantle 41 which surrounds the rotor, in in some cases entirely, wherein the rotor axis of rotation D (or its extension) in the embodiment shown forms an acute angle with the longitudinal axis L (see dashed lines), wherein the intersection of the longitudinal axis L and the rotor axis of rotation D and the energy conversion system 1 are closer to the rear end than to the front end of the vehicle. As can be seen from FIG. 1, the longitudinal axis L forms the leg of the acute angle lying below the rotor axis of rotation (or its extension). The flow housing 4 comprises two wind funnels 42, 43, which are adapted and arranged to guide a headwind W, in some cases a headwind airflow, to the rotor 3, wherein the first wind funnel 42 is arranged upstream of the rotor mantle 41 and tapers in the direction of the rotor mantle 41, and/or a second wind funnel 43 is arranged downstream of the rotor mantle 41 and widens in the direction away from the rotor mantle 41, wherein the first wind funnel 42 is adapted and arranged to receive the headwind W, and the second wind funnel 43 is adapted and arranged to direct the output airflow A in the direction of the vehicle end counter to the direction of travel F, in some case to the guiding unit 50.

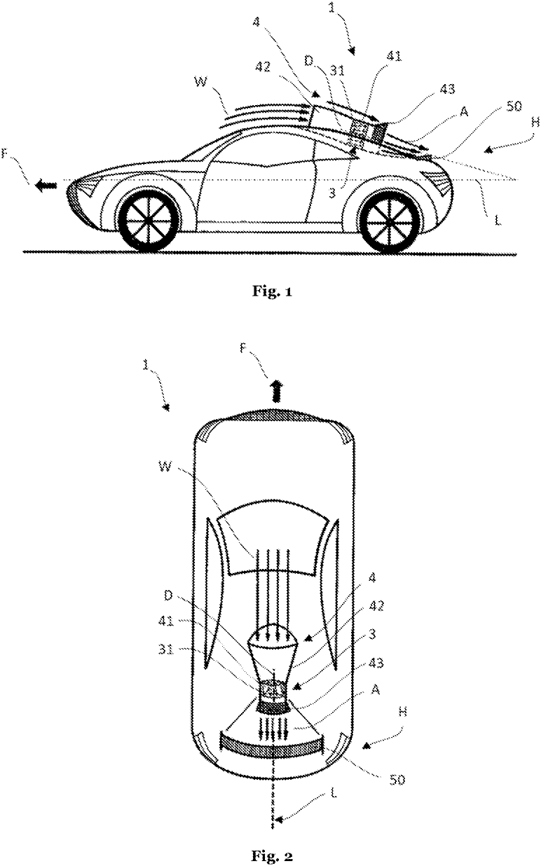

FIG. 2 shows a plan view of the passenger car described in FIG. 1.

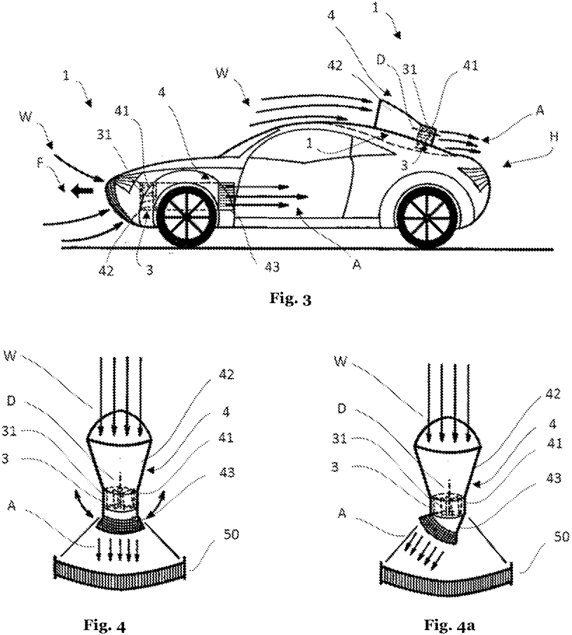

FIG. 3 shows the passenger car described in FIG. 1 in an alternative embodiment in which only the first wind funnel 42 is used and no guiding unit 50 is present either on the vehicle. Furthermore, the passenger car described in FIG. 3 comprises a second energy conversion system 1 which is located in the interior of the vehicle.

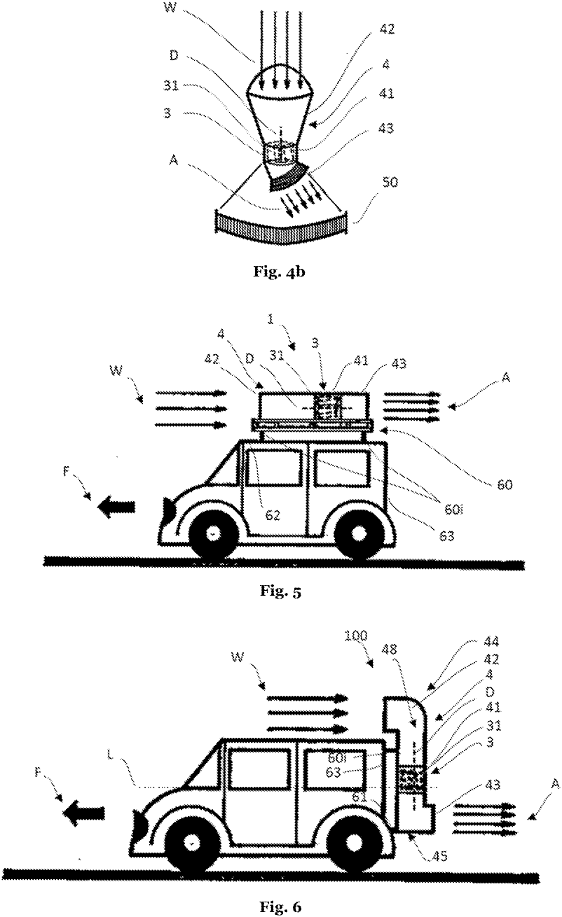

FIGS. 4, 4a, and 4b show plan views of an energy conversion system 1, wherein the second wind funnel 43 is arranged so as to be pivotably movable, in some cases mechanically, electrically, pneumatically and/or hydraulically pivotably movable, transverse to the vehicle longitudinal axis L about the end of the rotor mantle 41, such that the inflow angle of the output airflow A with respect to the guiding unit 50, in some cases spoiler, of a vehicle changes, in some cases changes by up to approximately 45° on both sides of the vehicle longitudinal axis L.

FIG. 5 shows a further embodiment of the passenger car according to the present disclosure with an energy conversion system 1, comprising a rotor 3 with a rotor axis of rotation D, comprising a plurality of rotor blades 31 extending radially with respect to the rotor axis of rotation D, a flow housing 4 with a rotor mantle 41, which surrounds the rotor entirely, a wind funnel 42 for guiding the headwind W on the rotor 3, a wind funnel 43 for discharging the output airflow in the direction of the vehicle end, and a mount 60, comprising two struts 60i, via which the mount 60, in in some cases a roof basket, is mounted on the roof 62 of the vehicle.

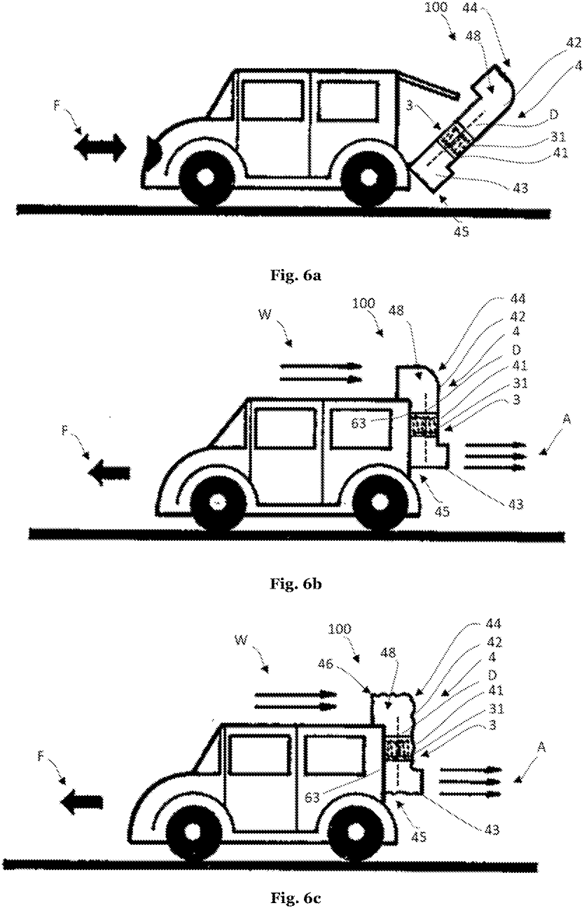

FIG. 6 shows a side view of the headwind deflection system 100 according to the present disclosure for passenger cars according to a fourth aspect of the present disclosure, comprising an energy conversion system 1 for converting wind energy into electrical energy, in some cases wind energy generated by headwind of the vehicle, comprising a rotor 3 with a rotor axis of rotation D, comprising a plurality of rotor blades 31 extending radially with respect to the rotor axis of rotation D, wherein the rotor 3 has an inflow direction which corresponds to the rotor axis of rotation D, in some cases is parallel to the rotor axis of rotation D, and a flow channel 48 with a rotor mantle 41 which surrounds the rotor, in some cases entirely, wherein the rotor axis of rotation D and the rotor mantle are arranged substantially vertically on the rear side of a vehicle, wherein the flow channel 48 comprises at least one first wind funnel 42 which is arranged above the roof of a vehicle, upstream with respect to the rotor, and adapted and arranged to guide headwind via a first manifold 44 and the rotor mantle to the rotor 3. The flow channel further includes a second manifold 45 at the transition from the rotor mantle to the second wind funnel, adapted and arranged to convey the headwind originating from the rotor away from the vehicle. The headwind deflection system from FIG. 6 is mounted on the rear side 63 of the vehicle via a strut 60i and via a coupling unit, such as a trailer hitch 61.

FIG. 6a shows a side view of an embodiment of the headwind deflection system 100 according to the present disclosure, as described in FIG. 6. However, this embodiment differs in that the headwind deflection system is attached to the vehicle in a foldable manner via a trailer hitch 61.

FIG. 6b shows a side view of a further embodiment of the headwind deflection system 100 according to the present disclosure, as described in FIG. 6. However, this embodiment differs in that the energy conversion system 1 is installed on the vehicle rear side 63 without struts and a trailer hitch, in some cases is installed by means of a belt system or lashing (not shown).

FIG. 6c shows a side view of an alternative embodiment of the headwind deflection system 100 according to the present disclosure as described in FIG. 6b, comprising a framework, in some cases in the form of a framework structure, for the flow housing 4 of the energy conversion system 1, comprising the rotor mantle 41 and optionally the first and second wind funnels 42, 43 and the first and second manifolds 44, 45, and a planar barrier device in the form of a sail 46, adapted and arranged to span the framework at least in sections, so that headwind can be directed to the at least one rotor 3.

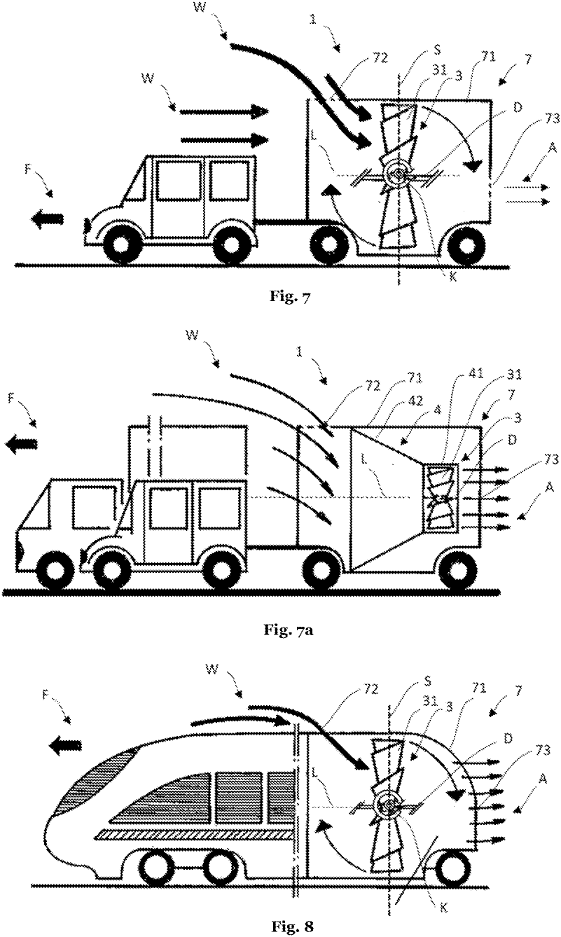

FIG. 7 shows a side view of a trailer 7 according to the present disclosure, such as a truck trailer, having a front end and a rear end and a longitudinal axis L extending between the front end and the rear end, comprising an energy conversion system 1 for converting wind energy into electrical energy, in some cases wind energy generated by headwind of a vehicle, having a rotor 3 with a rotor axis of rotation D, comprising a plurality of rotor blades 31 extending radially with respect to the rotor axis of rotation D, wherein the rotor axis of rotation D in the embodiment shown is oriented substantially parallel to the longitudinal axis L. The trailer 7 also has a trailer shell 71, comprising an opening 72, which is adapted and arranged to receive the headwind, and an outlet 73, which is adapted and arranged to discharge the output airflow to the surroundings of the trailer. The rotor 3 is pivotably movable transverse to the rotor axis of rotation D about a vertical pivot axis S and via a horizontal tilt axis K, in some cases between at least two rotor orientations, in some cases relative to the trailer shell 71.

FIG. 7a shows a side view of an alternative embodiment of a trailer 7 according to the present disclosure, as described in FIG. 7, further comprising a flow housing 4 with a rotor mantle 41 which surrounds the rotor entirely and a wind funnel 42 which is adapted and arranged to guide a headwind W, in some cases a headwind airflow, to the rotor 3, wherein the wind funnel 42 is arranged upstream of the rotor mantle 41 and tapers in the direction of the rotor mantle 41, wherein the wind funnel 42 is adapted and arranged to receive headwind W.

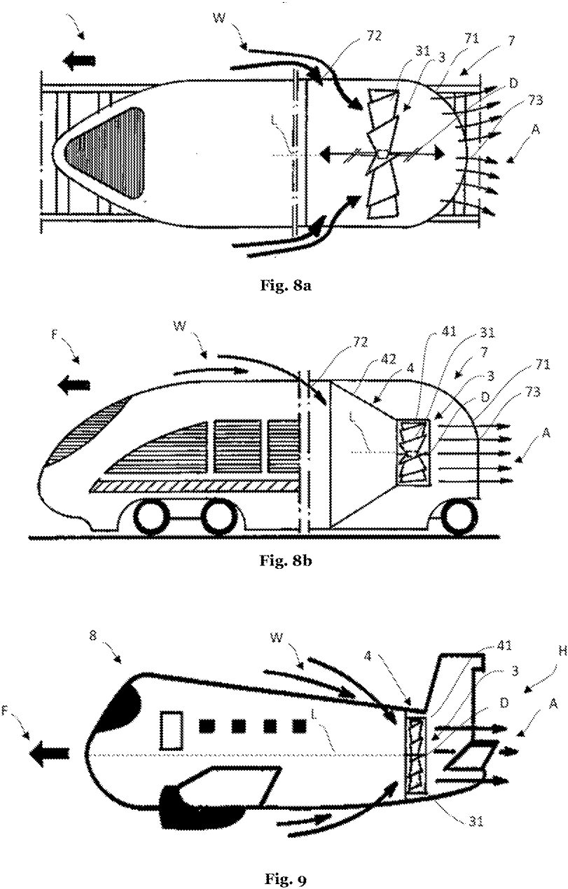

FIG. 8 shows a side view of a further embodiment of the trailer 7 according to the present disclosure, as described in FIG. 7, with the difference that the trailer is a train car.

FIG. 8a shows a plan view of a further embodiment of the trailer 7 according to the present disclosure, as described in FIG. 7, with the difference that the trailer is a train car and that the trailer is shown in a plan view.

FIG. 8b shows a further embodiment of the trailer 7 according to the present disclosure, as described in FIG. 7a, with the difference that the trailer is a train car.

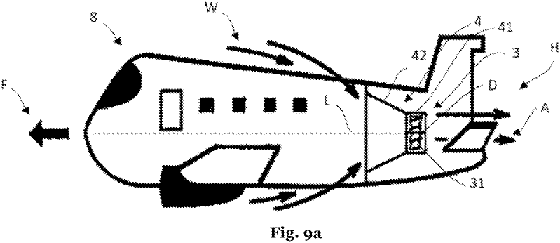

FIG. 9 shows a side view of an aircraft 8 according to the present disclosure, comprising an energy conversion system 1 for converting wind energy into electrical energy, in some cases wind energy generated by headwind of the aircraft, comprising a rotor 3 with a rotor axis of rotation D, comprising a plurality of rotor blades 31 extending radially with respect to the rotor axis of rotation D, wherein the rotor 3 has an inflow direction which corresponds to the rotor axis of rotation D, in some cases is parallel to the rotor axis of rotation D, and a flow housing 4 having a rotor mantle 41 which surrounds the rotor, in some cases entirely, wherein the rotor axis of rotation D is oriented substantially parallel to the longitudinal axis L of the aircraft.

FIG. 9a shows an alternative embodiment of an aircraft 8 according to the present disclosure, as described in FIG. 9, further comprising a wind funnel 42, which is adapted and arranged to guide a headwind W, in some cases a headwind airflow, to the rotor 3, wherein the wind funnel 42 is arranged upstream of the rotor mantle 41 and tapers in the direction of the rotor mantle 41, wherein the wind funnel 42 is adapted and arranged to receive headwind W.

The features of the present disclosure disclosed in the above description, in the claims and in the drawings can be essential both individually and in any combination for implementing the present disclosure in its various embodiments.

### REFERENCE SIGNS

1 Energy conversion system
3 Rotor
31 Rotor blades
4 Flow housing
41 Rotor mantle
42 First funnel
43 Second funnel
44 Manifold
45 Manifold
46 Sail
48 Flow channel
50 Guiding unit
60 Mount
60i Strut
61 Trailer hitch
62 Roof
63 Rear side
7 Trailer
71 Trailer shell
72 Opening
73 Outlet
8 Aircraft
100 Headwind deflection system
A Output airflow
D Rotor axis of rotation
F Direction of travel
H Rear
L Longitudinal axis
S Pivot axis
K Tilt axis
W Headwind

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A vehicle being a car or truck, having a front end and a rear end and a longitudinal axis extending between the front end and the rear end, and having at least one energy conversion system for converting wind energy generated by a headwind of the vehicle into electrical energy comprising:
at least one rotor having a rotor axis of rotation, comprising a plurality of rotor blades extending radially with respect to the rotor axis of rotation, wherein the at least one rotor has an inflow direction which corresponds to the rotor axis of rotation, and
a flow housing with a rotor mantle, which surrounds the at least one rotor,
wherein the rotor rotation axis is oriented substantially parallel to the longitudinal axis or forms an acute angle with the longitudinal axis, wherein an intersection of the longitudinal axis and the rotor axis of rotation is closer to the rear end than to the front end of the vehicle, and wherein the energy conversion system is closer to the rear end than to the front end of the vehicle.

2. The vehicle according to claim 1, wherein the flow housing further comprises at least one wind funnel, which is adapted and arranged to guide the headwind to the at least one rotor.

3. The vehicle according to claim 2, wherein a first wind funnel is arranged upstream of the rotor mantle and tapers in a direction of the rotor mantle, or a second wind funnel is arranged downstream of the rotor mantle and widens in a direction away from the rotor mantle, and
wherein the first wind funnel is adapted and arranged to receive the headwind and the second wind funnel is adapted and arranged to direct an output airflow in a direction of the vehicle end counter to a direction of travel of the vehicle.

4. The vehicle according to claim 1, wherein the at least one rotor is arranged in the rotor mantle at an axial distance from one or more wind funnels.

5. The vehicle according to claim 2, wherein the second wind funnel is arranged so as to be pivotably movable transverse to the vehicle longitudinal axis about an end of the rotor mantle, such that an inflow angle of an output airflow with respect to a guiding unit of a vehicle changes.

6. The vehicle according to claim 1, wherein the energy conversion system is mounted on a roof, a roof rack, a roof basket, or a roof box of the vehicle via a mount comprising at least one strut.

7. A trailer having a front end and a rear end and a longitudinal axis extending between the front end and the rear end, comprising at least one energy conversion system for converting wind energy generated by a headwind of the trailer into electrical energy, the at least one energy conversion system having at least one rotor with a rotor axis of rotation, comprising a plurality of rotor blades extending radially with respect to the rotor axis of rotation,
wherein the rotor axis of rotation is oriented substantially parallel to the longitudinal axis or forms an acute angle with the longitudinal axis, wherein an intersection of the longitudinal axis and the rotor axis of rotation is closer to the rear end than to the front end of the trailer.

8. The trailer according to claim 7, wherein the at least one rotor is pivotably movable transverse to the rotor axis of rotation.

9. An aircraft comprising an energy conversion system for converting wind energy generated by a headwind of the aircraft into electrical energy, comprising:
at least one rotor having a rotor axis of rotation, comprising a plurality of rotor blades extending radially with respect to the rotor axis of rotation, wherein the at least one rotor has an inflow direction which corresponds to the rotor axis of rotation, and
a flow housing with a rotor mantle, which surrounds the at least one rotor,
wherein the rotor axis of rotation is oriented substantially parallel to the longitudinal axis of the aircraft.

10. The aircraft according to claim 9, wherein the flow housing further comprises at least one wind funnel, which is adapted and arranged to guide the headwind to the at least one rotor.

11. Use of an energy conversion system according to claim 1 for improving the driving characteristics of the vehicle.

12. A headwind deflection system for vehicles comprising an energy conversion system for converting wind energy into electrical energy comprising:
at least one rotor having a rotor axis of rotation, comprising a plurality of rotor blades extending radially with respect to the rotor axis of rotation, wherein the at least one rotor has an inflow direction which corresponds to the rotor axis of rotation, and
a flow channel with a rotor mantle, which surrounds the rotor,
wherein the rotor axis of rotation and the rotor mantle can be arranged substantially vertically on a rear side of a vehicle, and
wherein the flow channel comprises a first wind funnel which can be arranged above a roof of the vehicle, upstream with respect to the at least one rotor, and is adapted and arranged to guide a headwind via a first manifold and the rotor mantle to the at least one rotor.

13. The headwind deflection system according to claim 12, further comprising:
a second wind funnel, which is present or can be arranged downstream with respect to the at least one rotor, adapted and arranged to guide the headwind away from the at least one rotor, and a second manifold in a transition from the rotor mantle to the second wind funnel, adapted and arranged to convey the headwind originating from the at least one rotor away from the vehicle.

14. The headwind deflection system according to claim 13, wherein the at least one rotor is arranged in the rotor mantle at an axial distance from the first or second wind funnel.

15. A kit of parts, comprising a vehicle in the form of a car or truck, and a headwind deflection system according to claim 12.

16. A kit of parts for a headwind deflection system according to claim 12, comprising:
a base structure for the flow housing of the energy conversion system, comprising the rotor mantle, the first wind funnel, and the first manifold; and
at least one planar barrier device adapted and arranged to span the base structure at least in sections so that the headwind can be directed to the at least one rotor.

17. The vehicle according to claim 1, wherein the at least one energy conversion system is present outside of a body of the vehicle.

18. The vehicle according to claim 1, wherein the inflow direction is parallel to the rotor axis of rotation.

19. The vehicle according to claim 1, wherein the energy conversion system is mounted on the rear of the vehicle.

20. The vehicle according to claim 5, wherein the guiding unit is a spoiler.

21. The vehicle according to claim 5, wherein the inflow angle of the output airflow with respect to the guiding unit changes by up to approximately 45° on both sides of the vehicle longitudinal axis.

22. The trailer according to claim 7, wherein a flow housing with a rotor mantle surrounds the at least one rotor.

23. The trailer according to claim 22, wherein the flow housing further comprises at least one wind funnel which is adapted and arranged to guide the headwind to the at least one rotor.

24. The trailer according to claim 22, wherein the flow housing further comprises first and second wind funnels,
wherein the first wind funnel is arranged upstream of the rotor mantle and tapers in the direction of the rotor mantle, and wherein the second wind funnel is arranged downstream of the rotor mantle and widens in a direction away from the rotor mantle,
wherein the first wind funnel is adapted and arranged to receive the headwind and the second wind funnel is adapted and arranged to direct an output airflow in a direction of the vehicle end counter to a direction of travel of the trailer.

25. The trailer according to claim 24, wherein the at least one rotor is arranged in the rotor mantle at an axial distance from the first and second wind funnels.

26. The trailer according to claim 7, wherein the at least one rotor is movable about a vertical pivot axis or a horizontal tilt axis.

27. The aircraft according to claim 9, wherein a first wind funnel is arranged upstream of the rotor mantle and tapers in a direction of the rotor mantle, and
wherein the first wind funnel is adapted and arranged to receive the headwind, and a second wind funnel is adapted and arranged to direct an output airflow in a direction of the aircraft counter to a direction of travel of the aircraft.

28. The use of an energy conversion system according to claim 11, wherein the driving characteristics of the vehicle are improved by increasing a contact pressure of the vehicle on a road.

29. The use of an energy conversion system according to claim 28, wherein the driving characteristics of the vehicle are improved on curved sections of the road.

30. The headwind deflection system according to claim 12, wherein the at least one rotor has an inflow direction which is parallel to the rotor axis of rotation.
